(19) United States
(12) Patent Application Publication
(10) Pub. No.: US 2023/0150794 A1
(43) Pub. Date: May 18, 2023

(54) DRIVE SYSTEM AND METHOD FOR CONTROLLING A DRIVE SYSTEM

(71) Applicant: Kone Corporation, Helsinki (FI)

(72) Inventor: Janne SALOMAKI, Helsinki (FI)

(73) Assignee: Kone Corporation, Helsinki (FI)

(21) Appl. No.: 18/152,486

(22) Filed: Jan. 10, 2023

Related U.S. Application Data
(63) Continuation of application No. PCT/EP20/71867, filed on Aug. 4, 2020.

(51) Int. Cl. B66B 1/30; B66B 1/34

(52) U.S. Cl. CPC B66B 1/304; B66B 1/3407

(57) ABSTRACT

An elevator control unit and a method for determining at least one position control feedforward torque parameter value of an elevator, the elevator comprising a drive system for driving an electric motor and an elevator control unit for controlling the drive system. The elevator control unit comprises position control means, and the position control means comprise means for determining position control feedforward torque, which means for determining position control feedforward torque comprises parameter values which relate to the elevator and/or components of the elevator. The method comprises driving at least one elevator test run, measuring and/or determining torque of the motor during the test run, and determining based at least in part on the position control feedforward torque and/or the measured and/or determined torque of the motor during the test run at least one of the following position control feedforward torque parameter values of the elevator position control means: a parameter value relating to balance, a parameter value relating to shaft efficiency, a parameter value relating to effective rope and/or car cable mass, a parameter value relating to total non-changing masses.

### CROSS-REFERENCE TO RELATED APPLICATION

This application is a continuation of PCT International Application No. PCT/EP2020/071867 which has an International filing date of Aug. 4, 2020, the entire contents of which are incorporated herein by reference.

### TECHNICAL FIELD

The invention concerns in general the technical field of drive systems for elevators.

### BACKGROUND

Typically, conveyors, such as elevators, comprise a drive system for controlling power feed to an electric motor of the conveyor in order to move a conveying entity, e.g. an elevator car. Moreover, the drive system controls the speed and torque of the electric motor. The drive system may comprise a drive control means and a frequency converter. The drive control means can generate e.g. a speed reference and a torque reference to the frequency converter, which controls the speed of the electric motor according to the speed reference and the torque according to the torque reference.

In a conveyor arrangement or system, the drive control means can be controlled by a control unit of the conveyor device, such as an elevator, and it can comprise for example position control means which defines the speed reference and the torque feedforward for the frequency converter. The final torque reference is a sum of torque feedforward and the speed controller output torque. If torque feedforward is not determined accurately, the speed controller has to correct the torque reference. In this kind of circumstances, e.g. smooth starts of the elevator ride can't be usually achieved.

In order to obtain good ride comfort for an elevator, elevator position or motion control needs tuning. In addition, also some supervisions, e.g. mechanical brake dragging, require that the motion control is tuned properly. Traditionally, the tuning is a complex and time-consuming procedure which includes running the elevator with different loads to different positions. The person carrying out the commissioning procedure must carefully observe the traction sheave movements and sometimes manually release the brake.

This kind of manual tuning procedure requires much expertise from the person carrying out the procedure and time and is also easily prone to errors of the installation and service personnel. For these reasons, there's a need for a solution which is more reliable and less time consuming.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention.

The following summary merely presents some concepts of the invention in a simplified form as a prelude to a more detailed description of exemplifying embodiments of the invention.

An objective of the invention is to present a method for determining at least one feedforward control parameter value of an elevator. An objective of the invention is also to present an elevator and an elevator control unit for controlling a drive system for driving an electric motor of an elevator.

The objectives of the invention are reached by an elevator, elevator control unit and a method as defined by the respective independent claims.

According to a first aspect, the invention relates to a method for determining at least one position control feedforward torque parameter value of an elevator, the elevator comprising a drive system for driving an electric motor and an elevator control unit for controlling the drive system. The elevator control unit comprises position control means, and the position control means comprise means for determining position control feedforward torque, which means for determining position control feedforward torque comprises parameter values which relate to the elevator and/or components of the elevator. The method comprises driving at least one elevator test run, measuring and/or determining torque of the motor during the test run, determining based at least in part on the position control feedforward torque and/or the measured and/or determined torque of the motor during the test run at least one of the following position control feedforward torque parameter values of the elevator position control means: a parameter value relating to balance, a parameter value relating to shaft efficiency, a parameter value relating to effective rope and/or car cable mass, a parameter value relating to total non-changing masses.

In one embodiment of the invention the elevator test run comprises at least one back and forth run between bottom and top floors, and at least one parameter value is determined based at least in part on the deter-mined torque during the test run or during a part of the test run.

In one embodiment of the invention measured and/or determined torque of the motor during the test run comprises average torque determined between certain predefined phases of the test run.

In one embodiment of the invention measured and/or determined torque of the motor during the test run comprises: average torque determined during constant acceleration when the elevator car is moving upwards and/or average torque determined during constant acceleration when elevator car is moving downwards, and/or average torque determined during constant speed when the elevator car is moving upwards and/or average torque determined during constant speed when the elevator car is moving downwards, and/or average torque determined during constant deceleration when the elevator car is moving upwards and/or average torque determined during constant deceleration when the elevator car is moving downwards.

In one embodiment of the invention elevator car positions are stored at certain phases of the test run for determining average torque between the phases, e.g. such that the elevator car positions are stored in the start and in the end of constant acceleration for determining the average torque during constant acceleration and/or in the start and in the end of constant deceleration for determining the average torque during constant deceleration and/or in the start and in the end of constant speed for determining the average torque during constant speed.

In one embodiment of the invention the method comprises determining the parameter value relating to balance based at least in part on average torque during constant speed upwards and average torque during constant speed downwards, and/or determining the parameter value relating to shaft efficiency based at least in part on average torque during constant speed upwards and average torque during constant speed downwards, and/or determining the parameter value relating to effective rope and/or car cable mass based at least in part on average torque rate per meter during constant speed, and/or determining the parameter value relating to total non-changing masses based at least in part on average torque during constant acceleration, average torque during constant speed, and average torque during constant deceleration.

In one embodiment of the invention a torque feed-forward value of the elevator position control means is determined based at least in part on the determined parameter values.

In one embodiment of the invention the torque feedforward value of the elevator position control means is determined based at least in part on static torque, dynamic torque and friction torque which are based at least in part on the determined parameter values.

According to a second aspect, the invention relates to an elevator control unit for controlling a drive system for driving an electric motor of an elevator, wherein the elevator control unit comprises position control means, and the position control means comprise means for determining position control feedforward torque, which means for determining position control feedforward torque comprises parameter values which relate to the elevator and/or components of the elevator. In the solution of the invention the elevator control unit is configured to control the drive system to drive at least one elevator test run, measure and/or determine torque of the motor during the test run, determine based at least in part on the position control feedforward torque and/or the measured and/or determined torque of the motor during the test run at least one of the following position controt feedforward torque parameter values of the elevator position control means:

a parameter value relating to balance, a parameter value relating to shaft efficiency, a parameter value relating to effective rope and/or car cable mass, a parameter value relating to total non-changing masses.

According to a third aspect, the invention relates to an elevator comprising an elevator car, an elevator motor configured to move the elevator car, a drive system for driving the elevator motor and an elevator control unit configured to control the elevator and/or the drive system.

With the solution of the invention a fast, reliable and automatic tuning procedure for the position control is enabled which is e.g. easy to use for the installation and/or the service personnel. In one embodiment of the invention only one back and forth run between bottom and top floors is needed to tune the position control parameters.

When the torque feedforward is determined as accurately as possible, the speed controller does not have to correct the torque reference much and this e.g. enables smooth starts. For these reasons also parameters relating to determining torque feedforward have to be tuned properly so that determining torque feedforward accurately is possible.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 presents one example implementation of torque reference formation for the elevator motor.

FIG. 2 presents a simplified structure of one example elevator implementation.

FIGS. 3A and 3B present speed and torque graphs relating to defining feedforward torque related parameters in an example upward run of an elevator.

FIGS. 4A and 4B present speed and torque graphs relating to defining feedforward torque related parameters in an example downward run of an elevator.

FIG. 5 presents an example method according to the present invention.

### DESCRIPTION OF THE EXEMPLIFYING EMBODIMENTS

In one embodiment an elevator comprises a driving machine comprising the electric motor for producing the driving force for moving an elevator car. The drive system is configured to control power feed to the electric motor in order to move the elevator car. Moreover, the drive system is configured to control the speed and/or torque of the electric motor.

The elevator may comprise at least one elevator car as the conveying entity arranged to travel along an elevator shaft between landings for transferring people and/or load. The driving machine of the elevator system may be an elevator hoisting machine comprising the electric motor in order to move the elevator car along the elevator shaft.

In one embodiment of the invention the drive system comprises a drive control means, such as a drive control unit, and a frequency converter. The drive control means can be controlled by e.g. motion control or position control. Drive control means are configured to generate, i.e. define, a speed reference of the electric motor and a torque reference of the electric motor. The speed reference represents the speed of the electric motor as a function of time. The drive control means is configured to provide the generated speed reference of the electric motor and the generated torque reference of the electric motor to the frequency converter. The frequency converter in configured to control the speed of the electric motor according to the speed reference and the torque of the electric motor according to the torque reference. The frequency converter can comprise an internal speed controller. The speed controller may be any type of speed controller comprising one or more adjustable operating parameters. The speed controller may be a proportional-integral (PI) controller.

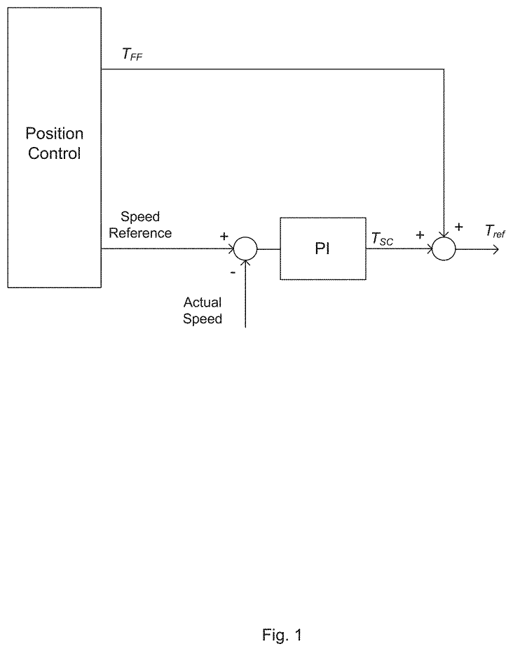

FIG. 1 presents one example implementation of torque reference formation for the elevator motor. The position control determines the speed reference and the torque feedforward T_{FF}. The final torque reference Trey in this example is a sum of at least torque feedforward and the speed controller output torque Tsc. It is important that torque feedforward is calculated as accurately as possible, so that the speed controller, such as PI (proportional-integral) controller, does not have to correct the torque reference much. That way smooth movement, e.g. starts, of the elevator car, can be accomplished.

In one embodiment of the invention, the position control can be implemented in a motion control unit or board. In one example it can be e.g. a separate unit or board between elevator main control board and frequency converter. The speed controller can be implemented in the frequency converter. In one embodiment the output of the motion control board or unit is the speed reference and the torque feedforward.

In the solution of the invention the determination of the torque feedforward T_{FF} parameter values can be done by driving at least one elevator test run, measuring and/or determining torque of the motor during the test run, determining based at least in part on the position control feedforward torque and/or the measured and/or determined torque of the motor during the test run at least one of the following position control feedforward torque parameter values of the elevator position control means: a parameter value relating to balance, a parameter value relating to shaft efficiency, a parameter value relating to effective rope and/or car cable mass, a parameter value relating to total non-changing masses.

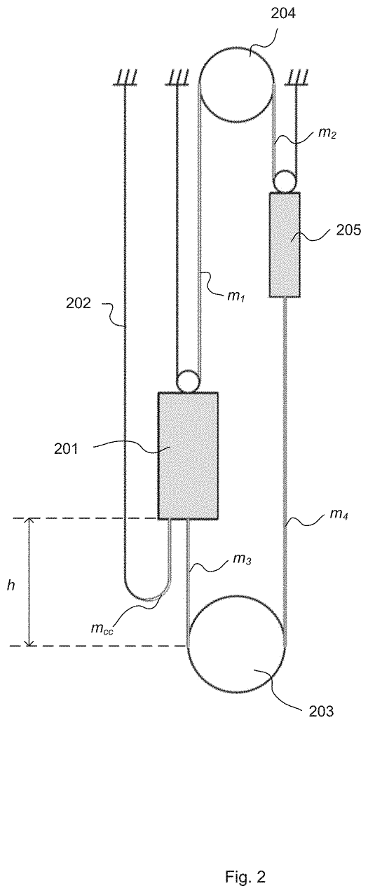

FIG. 2 presents a simplified structure of one example elevator implementation, which can be e.g. a high-rise elevator. The example implementation comprises an elevator car 201, a car cable 202, a compensator 203, a traction sheave 204, and a counterweight 205. The rope and car cable masses m_{cc}, m₁, m₂, m₃, m₄ that are supported by the traction sheave 204 are marked with a double line. The symbols used in the following equations are:
car and sling mass: m_{cs}
counterweight mass: m_{cw}
load mass: m_{L}
nominal load: m_{L,nom}
traction sheave radius (or diameter): r
motor and traction sheave inertia Jₘ
compensator inertia J_{c}
gravitational acceleration g
rope reeving ratio iᵣ
shaft height: Hₛ

Total feedforward torque can be a combination of static torque, dynamic torque and friction torque. In the following some examples are presented how static torque, dynamic torque and friction torque can be defined based on elevator system specific constants or operating data which can for example be collected based on a test run.

In one example, elevator balance can be determined in e.g. the middle of the shaft, where the masses are:

m₁=m₂

m₃=m₄

m_{L}+m_{cs}+m_{cc}=m_{cw}

In the balanced situation, the load mass is m_{L}=bm_{L,nom,}, where b is a balance parameter. In the middle of the shaft, the car cable mass can be defined by car cable mass per meter and shaft height. Also the rope masses are proportional to the car position and thus mass of the rope is proportional to compensation rope mass per meter and height of the elevator car.

For defining static torque the torque needed to hold up all masses has to be defined. Based on this and the above, the static torque can be defined as:

$${T}_{S} = \frac{r g}{{i}_{r}} ( {m}_{L} - b {m}_{L , n o m} ) + r g ( {H}_{S} - 2 h ) {ρ}_{tot}$$

The mass per meter values of ropes and car cable can be reduced into one parameter ρₜₒₜ.

For defining dynamic torque in this example, all moving masses can be reduced to an inertia at the motor shaft. The car cable mass can be neglected. The total inertia is proportional to inertia of the motor and traction sheave, inertia of all the masses, and inertia of the compensator.

The dynamic torque is then proportional to total inertia and acceleration reference of the car, and thus it can defined as:

$${T}_{D} = \frac{( {m}_{L} + {M}_{a} ) r {a}_{ref}}{{i}_{r}}$$

where Mₐ is the total non-changing masses reduced into one parameter and where a_{ref} is the acceleration reference of the car.

The total non-changing masses Mₐ relate to at least one of the following: a part of the mass of the car, mass of the sling, mass of the counterweight, mass of the compensator, mass of the machinery and rope masses of the elevator system. In one embodiment the total non-changing masses Mₐ relate to masses of all previously listed components and this way an accurate feedforward torque determination can be achieved.

For defining the friction torque, it has to be taken into account that there are several kind of mechanical losses in the elevator, such as friction in guide rollers, friction in rope pulleys and air resistance. If all losses are simplified to be a function of car speed, friction torque can be defined in this example as:

$${T}_{F} = ( 1 - η ) {T}_{n o m} \frac{v}{{v}_{n o m}}$$

where η is shaft efficiency and Tₙₒₘ is the elevator nominal torque. It is defined in this example as

$${T}_{n o m} = \frac{{m}_{L , n o m} ( 1 - b ) r g}{η {i}_{r}}$$

Based on the above, the total feedforward torque can be defined in this example as:

T_{FF}=Tₛ+T_{D}+T_{F}

In one embodiment the feedforward torque can be calculated in motion control unit according to previous equation for T_{FF}. Based on this the inputs for the feedforward torque determination in one example embodiment can be at least one of the following: load mass m_{L} (measured e.g. with a scale in the car), car position h, car speed v, the speed reference v_{ref}, acceleration reference a_{ref}.

The parameters, which can e.g be automatically tuned, for the feedforward torque can be for example: radius of the traction sheave (r), rope reeving ratio (iᵣ), balance (b), nominal load (m_{L,nom}), shaft height (Hₛ) effective rope and car cable mass (ρₜₒₜ), total non-changing masses (Mₐ), and/or shaft efficiency (η).

In one example of the invention an automatic tuning process is configured to determine parameter values for at least one of the following: balance parameter (b), shaft efficiency (η), mass per meter values of ropes and car cable and total non-changing masses (Mₐ).

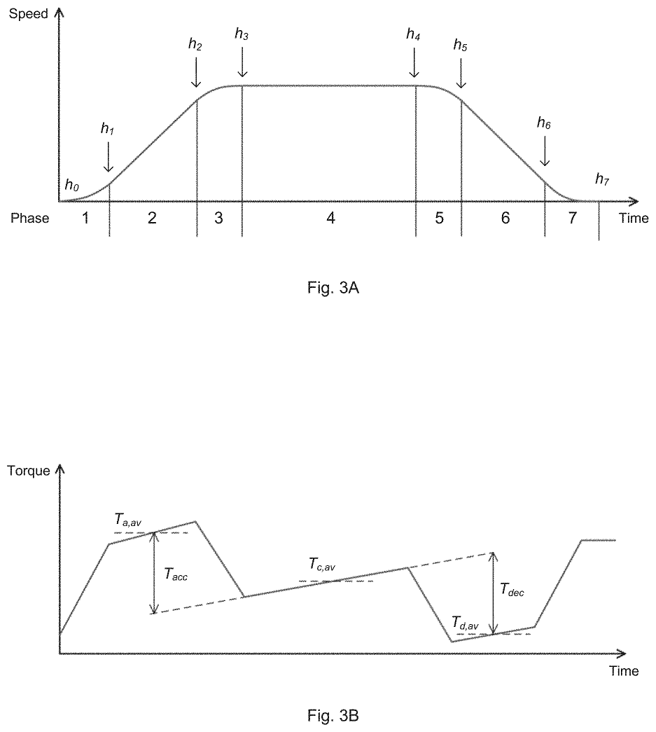

FIGS. 3A and 3B present speed and torque graphs relating to defining feedforward torque related parameters in an example upward run of an elevator. In case of FIGS. 3A and 3B the load mass is such that the car side is heavier than the counterweight.

Before the drive of the electric motor is initiated, i.e. when the state of the electric motor and elevator are stationary, the drive control means is configured to define the speed reference of the electric motor. Furthermore, the drive control means is configured to define instants of time, when the state of the electric motor changes based on the defined speed reference. In the example of FIGS. 3A and 3B, at the instant of time of h₀ the speed of the electric motor starts to increase causing that the state of the electric motor changes from the stationary to accelerating at the instant of time of h₀. The acceleration may be increasing as illustrated in FIG. 3A between the instant of time h₀ and the instant of time h₁, constant as illustrated in FIG. 3A between the instant of time h₁ and the instant of time h₂, or decreasing as illustrated in FIG. 3A between the instant of time h₂ and the instant of time h₃. At the instant of time of h₃ the speed of the electric motor reaches a constant speed causing that the state of the electric motor changes from the accelerating to the constant at the instant of time of h₃. At the instant of time of h₄ the speed of the electric motor starts to decrease from the constant speed causing that the state of the electric motor changes from the constant to decelerating at the instant of time of h₄. The deceleration may be increasing as illustrated in FIG. 3A between the instant of time h₄ and the instant of time h₅, constant as illustrated in FIG. 3A between the instant of time h₅ and the instant of time h₆, or decreasing as illustrated in FIG. 3A between the instant of time h₆ and the instant of time h₇. At the instant of time of h₇ the drive of the electric motor stops, i.e. the speed of the electric motor at the instant of time h₇ is zero, causing that the state of the electric motor changes from the decelerating to the stationary again at the instant of time of h₇.

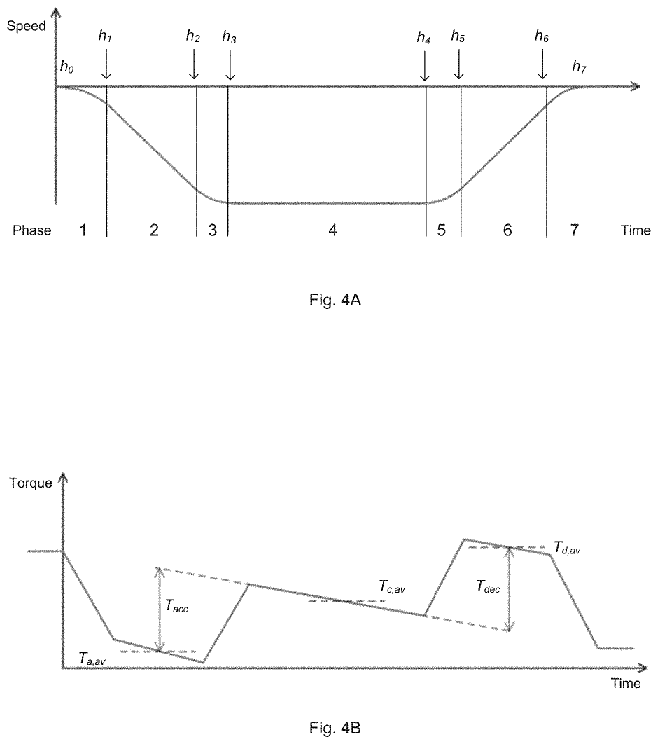

FIGS. 4A and 4B are otherwise similar presentation as FIGS. 3A and 3B but they present speed and torque graphs relating to defining feedforward torque related parameters in an example downward run of an elevator.

The following paragraphs present examples of how the parameters can be estimated.

Lift balance calculation estimates how much more weights should be added to the counterweight in order to obtain balance between car and counterweight in the middle of the shaft. The calculation is based on the average motor torque in both run directions as follows:

$${\hat{m}}_{b} = \frac{{T}_{up , av} + {T}_{down , av}}{2 r g} {i}_{r}$$

where T_{up,av} is the average torque during constant speed upwards and T_{down,av} is the average torque during constant speed downwards.

The balance parameter can be calculated as

$$\hat{b} = \frac{{\hat{m}}_{b} - {m}_{L}}{{m}_{L , nom}}$$

The shaft efficiency can be calculated from the same average torques as the balance estimate. The friction torque is

$${T}_{fric} = \frac{{T}_{up , av} - {T}_{d o w n , a v}}{2}$$

The measured shaft efficiency is

$$η = 1 - \frac{{T}_{fric}}{{T}_{n o m}}$$

Effective rope and car cable mass is estimated based on one run. A torque rate per meter can be defined as

$$( \frac{Δ T}{Δ h} ) = \frac{{T}_{n} - {T}_{n - 1}}{{h}_{n} - {h}_{n - 1}}$$

where Tₙ is the current motor torque, Tₙ₋₁ is the previous motor torque, hₙ is the current position and hₙ₋₁ is the previous position. The sampling rate in one example embodiment can be e.g around 50 ms.

During constant speed, the average of ΔT/Δh is calculated. After run, the estimate of the effective rope and car cable mass is calculated as

$${\hat{ρ}}_{tot} = {( \frac{Δ T}{Δ h} )}_{av} \frac{1}{2 r g}$$

The total non-changing masses can be estimated from average motor torque at different run phases. The car position and the effective rope and car cable mass are taken into account in the calculation.

In the examples of FIGS. 3A and 3B and FIGS. 4A and 4B, in one embodiment of the invention, the car positions are stored in the end of phases 1, 2, 5 and 6. The average torque is calculated during constant acceleration T_{a,av}, during constant speed T_{c,av}, and during constant deceleration T_{d,av}.

The middle point of the acceleration is hₐ=(h₁+h₂)/2 and the middle point of the deceleration is h_{d}=(h₅+h₆)/2. The car position at the middle of the run is h_{c}=(hₐ+h_{d})/2. The acceleration torque is

$${T}_{a c c} = {T}_{a , a v} - {T}_{c , av} - ( {h}_{a} - {h}_{c} ) {( \frac{Δ T}{Δ h} )}_{av}$$

The deceleration torque is

$${T}_{dec} = {T}_{d , a v} - {T}_{c , av} - ( {h}_{d} - {h}_{c} ) {( \frac{Δ T}{Δ h} )}_{av}$$

The average torque needed for acceleration and deceleration is

$${T}_{ad , av} = \frac{\vert {T}_{a c c} \vert + \vert {T}_{d e c} \vert}{2}$$

The estimate of total non-changing masses can be calculated based on equation for T_{D}

$${\overline{M}}_{a} = \frac{{T}_{ad , av} {i}_{r}}{r {a}_{ref}} - {m}_{L}$$

In one embodiment of the invention elevator position control can be tuned automatically by running a test run from the bottom floor to the top floor and back. In one embodiment the following parameters can be tuned by using the information obtained during the test runs: balance, shaft efficiency, effective rope and car cable mass and total non-changing masses. When these parameters are tuned correctly this enables smooth starts and stoppings and expected behavior of supervision functions.

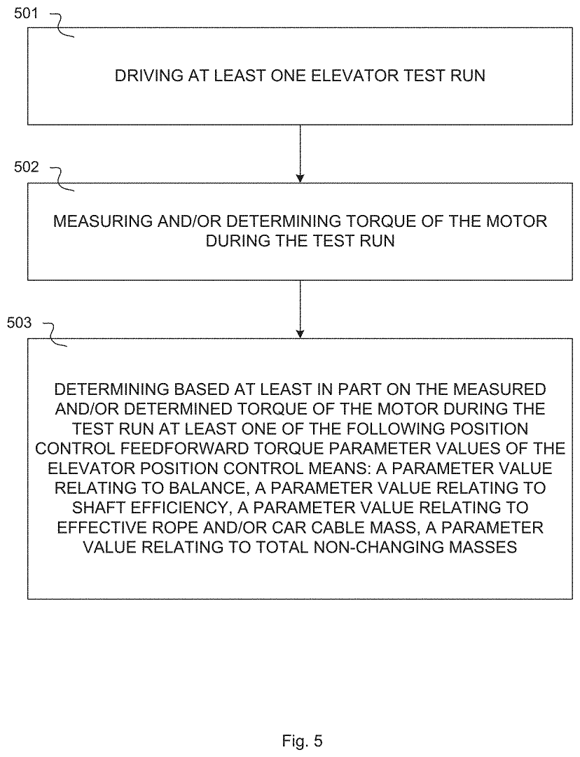

FIG. 5 presents an example method according to the present invention. The first step 501 of the method comprises driving at least one elevator test run. Then the second step 502 comprises measuring and/or determining torque of the motor during the test run. The third step 503 of the method comprises determining based at least in part on the measured and/or determined torque of the motor during the test run at least one of the following position control feedforward torque parameter values of the elevator position control means: a parameter value relating to balance, a parameter value relating to shaft efficiency, a parameter value relating to effective rope and/or car cable mass, a parameter value relating to total non-changing masses.

In one embodiment of the invention the drive control means may be a separate unit or may be comprised in or as a part of other units, e.g. the frequency converter and/or in elevator implementations the drive control means may be comprised in or as a part of an elevator control unit. The drive control means may also be arranged in distributed manner at more than two locations or in more than two units. The drive control means may comprise one or more processors, one or more memories being volatile or non-volatile for storing portions of computer program code and any data values, one or more communication interface units and possibly one or more user interface units. The mentioned elements may be communicatively coupled to each other with e.g. an internal bus. The processor may be configured to execute at least some portion of a computer program code stored in the memory causing the processor, and thus the drive control means, to perform desired tasks, e.g. the operations of the drive control means and/or at least some of the method steps described above. The processor may thus be arranged to access the memory and retrieve and store any information therefrom and thereto. For sake of clarity, the processor herein refers to any unit suitable for processing information and control the operation of the drive control unit, among other tasks. The operations may also be implemented with a microcontroller solution with embedded software. Similarly, the memory is not limited to a certain type of memory only, but any memory type suitable for storing the described pieces of information may be applied in the context of the present invention. The communication interface unit provides an interface for communication with any external unit. The communication interface unit may be based on one or more known communication technologies, either wired or wireless, in order to exchange pieces of information. The one or more user interface units may comprise one or more input/output (I/O) devices, such as buttons, keyboard, touch screen, microphone, loudspeaker, display and so on, for receiving input and outputting information.

The specific examples provided in the description given above should not be construed as limiting the applicability and/or the interpretation of the appended claims. Lists and groups of examples provided in the description given above are not exhaustive unless otherwise explicitly stated.

1. A method for determining at least one position control feedforward torque parameter value of an elevator, the elevator comprising a drive system for driving an electric motor and an elevator control unit for controlling the drive system,
wherein the elevator control unit comprises position control means, and the position control means comprise means for determining position control feedforward torque, which means for determining position control feedforward torque comprises parameter values which relate to the elevator and/or components of the elevator,
wherein the method comprises:
driving at least one elevator test run,
measuring and/or determining torque of the motor during the test run,
determining based at least in part on the position control feedforward torque and/or the measured and/or determined torque of the motor during the test run at least one of the following position control feedforward torque parameter values of the elevator position control means: a parameter value relating to balance, a parameter value relating to shaft efficiency, a parameter value relating to effective rope and/or car cable mass, a parameter value relating to total non-changing masses.

2. A method according to claim 1, wherein the elevator test run comprises at least one back and forth run between bottom and top floors, and at least one parameter value is determined based at least in part on the determined torque during the test run or during a part of the test run.

3. A method according to claim 1, wherein measured and/or determined torque of the motor during the test run comprises average torque determined between certain predefined phases of the test run.

4. A method according to claim 1, wherein measured and/or determined torque of the motor during the test run comprises:
average torque determined during constant acceleration when the elevator car is moving upwards and/or average torque determined during constant acceleration when elevator car is moving downwards, and/or
average torque determined during constant speed when the elevator car is moving upwards and/or average torque determined during constant speed when the elevator car is moving downwards, and/or
average torque determined during constant deceleration when the elevator car is moving upwards and/or average torque determined during constant deceleration when the elevator car is moving downwards.

5. A method according claim 1, wherein elevator car positions are stored at certain phases of the test run for determining average torque between the phases, e.g. such that the elevator car positions are stored in the start and in the end of constant acceleration for determining the average torque during constant acceleration and/or in the start and in the end of constant deceleration for determining the average torque during constant deceleration and/or in the start and in the end of constant speed for determining the average torque during constant speed.

6. A method according to claim 1, wherein the method comprises:
determining the parameter value relating to balance based at least in part on average torque during constant speed upwards and average torque during constant speed downwards, and/or
determining the parameter value relating to shaft efficiency based at least in part on average torque during constant speed upwards and average torque during constant speed downwards, and/or
determining the parameter value relating to effective rope and/or car cable mass based at least in part on average torque rate per meter during constant speed, and/or
determining the parameter value relating to total non-changing masses based at least in part on average torque during constant acceleration, average torque during constant speed, and average torque during constant deceleration.

7. A method according to claim 1, wherein a torque feedforward value of the elevator position control means is determined based at least in part on the determined parameter values.

8. A method according to claim 7, wherein the torque feedforward value of the elevator position control means is determined based at least in part on static torque, dynamic torque and friction torque which are based at least in part on the determined parameter values.

9. Elevator control unit for controlling a drive system for driving an electric motor of an elevator, wherein the elevator control unit comprises position control means, and the position control means comprise means for determining position control feedforward torque, which means for determining position control feedforward torque comprises parameter values which relate to the elevator and/or components of the elevator,
wherein the elevator control unit is configured to:
control the drive system to drive at least one elevator test run,
measure and/or determine torque of the motor during the test run,
determine based at least in part on the position control feedforward torque and/or the measured and/or determined torque of the motor during the test run at least one of the following position control feedforward torque parameter values of the elevator position control means: a parameter value relating to balance, a parameter value relating to shaft efficiency, a parameter value relating to effective rope and/or car cable mass, a parameter value relating to total non-changing masses.

10. An elevator control unit according to claim 9, wherein the elevator test run comprises at least one back and forth run between bottom and top floors, and the elevator control unit and/or the drive system is configured to determine at least one parameter value based at least in part on the determined torque during the test run or during a part of the test run.

11. An elevator control unit according to claim 9, wherein measured and/or determined torque of the motor during the test run comprises average torque which the elevator control unit and/or the drive system is configured to determine between certain predefined phases of the test run.

12. An elevator control unit according to claim 9, wherein measured and/or determined torque of the motor during the test run comprises:
average torque determined during constant acceleration when the elevator car is moving upwards and/or average torque determined during constant acceleration when elevator car is moving downwards, and/or
average torque determined during constant speed when the elevator car is moving upwards and/or average torque determined during constant speed when the elevator car is moving downwards, and/or
average torque determined during constant deceleration when the elevator car is moving upwards and/or average torque determined during constant deceleration when the elevator car is moving downwards.

13. An elevator control unit according to claim 9, wherein the elevator control unit and/or the drive system is configured to store elevator car positions at certain phases of the test run for determining average torque between the phases, e.g. such that the drive system is configured to store the elevator car positions in the start and in the end of constant acceleration for determining the average torque during constant acceleration and/or in the start and in the end of constant deceleration for determining the average torque during constant deceleration and/or in the start and in the end of constant speed for determining the average torque during constant speed.

14. An elevator control unit according to claim 9, wherein
the elevator control unit and/or the drive system is configured to determine the parameter value relating to balance based at least in part on average torque during constant speed upwards and average torque during constant speed downwards, and/or
the elevator control unit and/or the drive system is configured to determine the parameter value relating to shaft efficiency based at least in part on average torque during constant speed upwards and average torque during constant speed downwards, and/or
the elevator control unit and/or the drive system is configured to determine the parameter value relating to effective rope and/or car cable mass based at least in part on average torque rate per meter during constant speed, and/or
the elevator control unit and/or the drive system is configured to determine the parameter value relating to total non-changing masses based at least in part on average torque during constant acceleration, average torque during constant speed, and average torque during constant deceleration.

15. An elevator control unit according to claim 9, wherein the elevator control unit and/or the drive system is configured to determine a torque feedforward value of the elevator position control means based at least in part on the determined parameter values.

16. An elevator control unit according to claim 9, wherein the elevator control unit and/or the drive system is configured to determine the torque feedforward value of the elevator position control means based at least in part on static torque, dynamic torque and friction torque which are based at least in part on the determined parameter values.

17. An elevator comprising
an elevator car,
an elevator motor configured to move the elevator car,
a drive system for driving the elevator motor,
an elevator control unit configured to control the elevator and/or the drive system,
wherein the elevator control unit is an elevator control unit according to claim 9.
